(19) United States
(12) Patent Application Publication
(10) Pub. No.: US 2018/0062805 A1
(43) Pub. Date: Mar. 1, 2018

(54) SETTING OF SPATIAL REUSE FIELD FOR HE TRIGGER-BASED PPDU

(71) Applicants: Po-Kai Huang, San Jose, CA (US); Laurent Cariou, Portland, OR (US); Robert J. Stacey, Portland, OR (US)

(72) Inventors: Po-Kai Huang, San Jose, CA (US); Laurent Cariou, Portland, OR (US); Robert J. Stacey, Portland, OR (US)

(21) Appl. No.: 15/474,778

(22) Filed: Mar. 30, 2017

Related U.S. Application Data
(60) Provisional application No. 62/379,410, filed on Aug. 25, 2016.

(51) Int. Cl. H04L 5/00; H04L 29/08; H04W 16/10

(52) U.S. Cl. CPC H04L 5/0044; H04W 84/12; H04W 16/10; H04L 69/323

(57) ABSTRACT

Methods, apparatuses, computer readable media for setting spatial reuse field for uplink trigger-based PPDU are disclosed. An apparatus of a wireless device can include processing circuitry configured to decode a high efficiency (HE) physical-layer convergence procedure (PLCP) protocol data unit (PPDU) comprising a high-throughput (HT) control field in a media access control (MAC) portion of the HE PPDU. The processing circuitry is further configured to determine whether the HT control field of the HE PPDU contains uplink (UL) multi-user (MU) response scheduling information soliciting a response. in response to determining the HT control field contains the UL MU response scheduling information, the processing circuitry can encode, for transmission, the response PPDU to include a spatial reuse (SR) field set to a default entry.

### PRIORITY CLAIM

This application claims the benefit of priority under 35 USC 119(e) to U.S. Provisional Patent Application Ser. No. 62/379,410, filed Aug. 25, 2016, which application is incorporated herein by reference in its entirety.

### TECHNICAL FIELD

Embodiments pertain to wireless networks and wireless communications, Some embodiments relate to Institute of Electrical and Electronic Engineers (IEEE) 802.11 family of standards. Some embodiments relate to high-efficiency (HE) wireless local-area networks (WLANs), Some embodiments relate to IEEE 802.11ax. Some embodiments relate computer readable media, methods, and apparatuses for setting of spatial reuse (SR) field for high efficiency (HE) trigger-based (TB) physical layer protocol data unit (PPDU).

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some aspects of the present disclosure;

FIG. 2. illustrates a front-end module circuitry for use in the radio architecture of FIG. 1 in accordance with some aspects of the present disclosure;

FIG. 3 illustrates a radio IC circuitry for use in the radio architecture of FIG. 1 in accordance with some aspects of the present disclosure;

FIG. 4 illustrates a baseband processing circuitry for use in the radio architecture of FIG. 1 in accordance with some aspects of the present disclosure;

FIG. 5 illustrates a WLAN in accordance with some embodiments;

FIG. 6 illustrates a physical layer convergence procedure (PLCP) protocol data unit (PPDU);

FIG. 7 illustrates a timing diagram of a method for setting spatial reuse (SR) field for high efficiency (HE) trigger-based (TB) PPDU in accordance with some embodiments;

FIG. 8 illustrates another timing diagram of a method for setting SR field for HE TB PPDU in accordance with some embodiments;

FIG. 9 illustrates yet another timing diagram of a method for setting SR field for HE TB PPDU in accordance with some embodiments;

FIG. 10 illustrates a method for setting SR field for HE TB PPDU in accordance with some embodiments;

FIG. 11 illustrates a method for setting SR field for HE TB PPDU in accordance with some embodiments;

FIG. 12 illustrates an HE station in accordance with some embodiments; and

FIG. 13 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

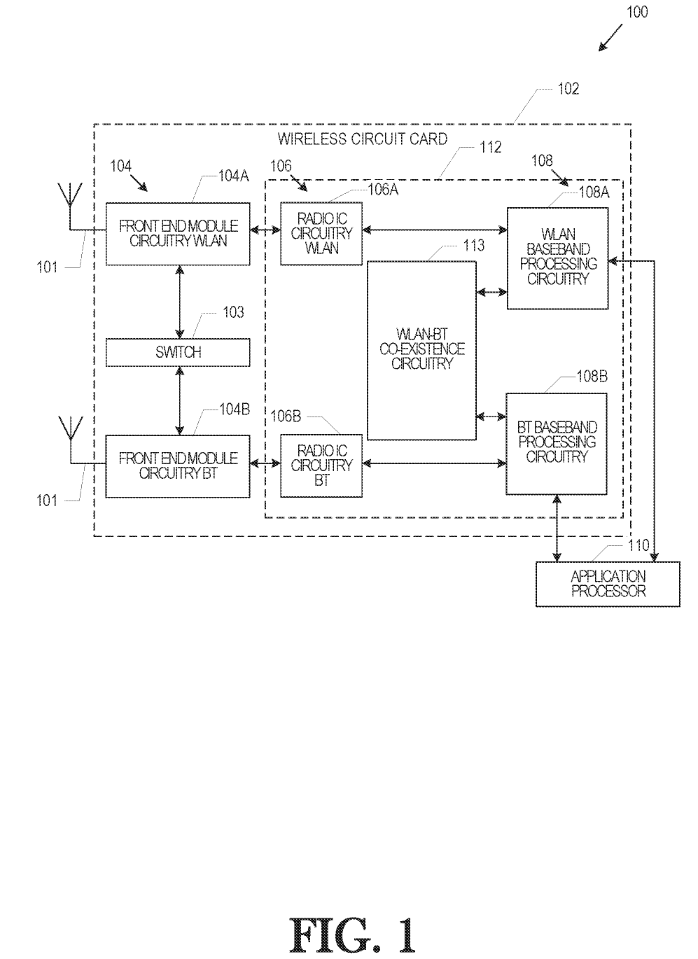

FIG. 1 is a block diagram of a radio architecture 100 in accordance with some aspects of the present disclosure. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although aspects of the disclosure are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify air signals provided by the radio IC circuitry 106B for wireless transmission by the one or more antennas 101. In the example of FIG. 1, although FEM 104A and FEM 104B are shown as being distinct from one another, aspects of the present disclosure are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106a The WLAN radio IC circuitry 106A may include a receive signal path which may include circuitry to down-convert WLAN RF signals received from the FEM. circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the example of FIG. 1, although radio IC circuitries 106A and 106B are shown as being distinct from one another, aspects of the present disclosure are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

In an example, the radio IC circuitry 106 can include one or more divider-less fractional phase locked loops (PLLs) for generating fractional frequency signals, such as signals with frequencies that are a fraction of a frequency of a reference signal.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 110 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, aspects of the present disclosure include within their scope the sharing of one or more antennas as between the WLAN and BT FEMs, or the provision of more than one antenna connected to each of FEM 104A or 104B.

In some aspects of the present disclosure, the front-end module circuitry 104, the radio IC circuitry 106, and baseband processing circuitry 108 may be provided on a single radio card, such as wireless radio card 102. In some other aspects of the present disclosure, the one or more antennas 101, the FEM circuitry 104 and the radio IC circuitry 106 may be provided on a single radio card. In some other aspects of the present disclosure, the radio IC circuitry 106 and the baseband processing circuitry 108 may be provided on a single chip or integrated circuit (IC), such as IC 112.

in some aspects of the present disclosure, the wireless radio card 102 may include a WLAN radio card and may be configured for Wi-Fi communications, although the scope of the aspects of the present disclosure is not limited in this respect. In some of these aspects of the present disclosure, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier aspects of the present disclosure, radio architecture 100 may be part of a Wi-Fi communication station (STA) such as a wireless access point (AP), a base station or a mobile device including a Wi-Fi device. In some of these aspects of the present disclosure, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2016, IEEE 802.11n-2009, IEEE 802.11ac, and/or IEEE 802.11ax standards and/or proposed specifications for WLANs, although the scope of aspects of the present disclosure is not limited in this respect. Radio architecture 100 may also be suitable to transmit and/or receive communications in accordance with other techniques and standards.

In some aspects of the present disclosure, the radio architecture 100 may be configured for high-efficiency (HE) Wi-Fi (HEW) communications in accordance with the IEEE 802.11ax standard. In these aspects of the present disclosure, the radio architecture 100 may be configured to communicate in accordance with an OFDMA technique, although the scope of the aspects of the present disclosure is not limited in this respect.

In some other aspects of the present disclosure, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the aspects of the present disclosure is not limited in this respect.

In some aspects of the present disclosure, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In aspects of the present disclosure that include BT functionality as shown for example in FIG. 1, the radio architecture 100 may be configured to establish a BT synchronous connection oriented (SCO) link and/or a BT low energy (BT LE) link. In some of the aspects of the present disclosure that include functionality, the radio architecture 100 may be configured to establish an extended SCO (eSCO) link for BT communications, although the scope of the aspects of the present disclosure is not limited in this respect. In some of these aspects of the present disclosure that include a HT functionality, the radio architecture may be configured to engage in a BT Asynchronous Connection-Less (ACL) communications, although the scope of the aspects of the present disclosure is not limited in this respect. In some aspects of the present disclosure, as shown in FIG. 1, the functions of a BT radio card and WLAN radio card may be combined on a single wireless radio card, such as single wireless radio card 102, although aspects of the present disclosure are not so limited, and include within their scope discrete WLAN and BT radio cards

In some aspects of the present disclosure, the radio-architecture 100 may include other radio cards, such as a cellular radio card configured for cellular (e.g., 3GPP such as LTE, LTE-Advanced or 5G communications).

In some IEEE 802.11 aspects of the present disclosure, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5MHz, 8 MHz, 10 MHz, 16 MHz, 20 MHz, 40 MHz, 80 MHz((with contiguous bandwidths) or 80+80 MHz (160 MHz) (with non-contiguous bandwidths). In some aspects of the present disclosure, a 320 MHz channel bandwidth may be used. The scope of the aspects of the present disclosure is not limited with respect to the above center frequencies however.

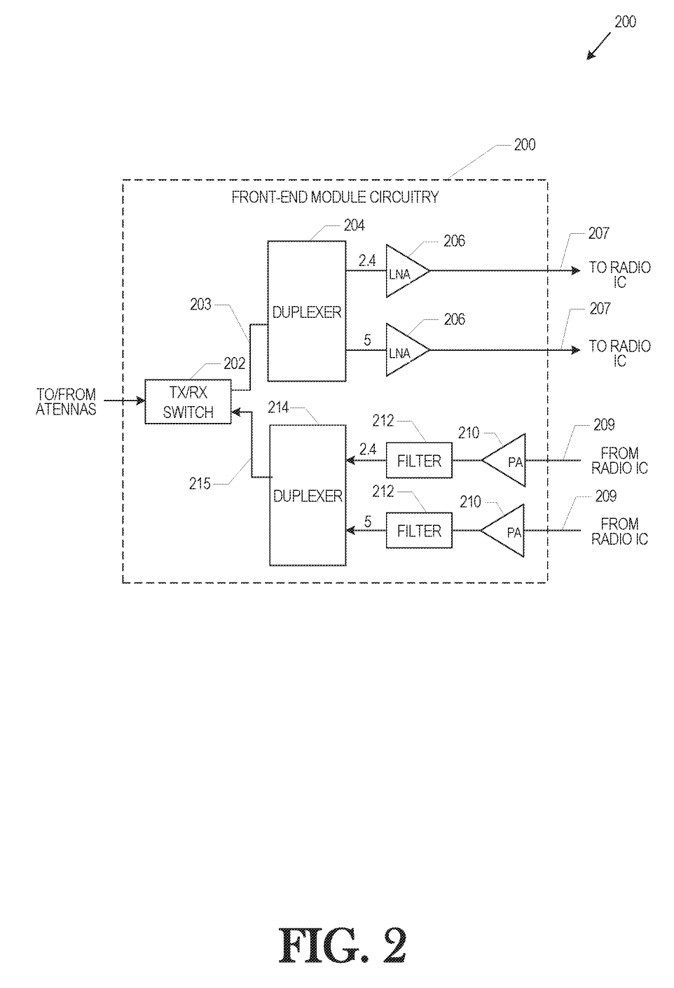

FIG. 2 illustrates FEM circuitry 200 in accordance with some aspects of the present disclosure. The FEM circuitry 200 is one example of circuitry that may be suitable for use as the WLAN and/or BT FEM circuitry 104A/104B (FIG. 1), although other circuitry configurations may also be suitable.

In some aspects of the present disclosure, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) 210 to amplify input RF signals 209 (e.g., provided by the radio IC circuitry 106), and one or more filters 212, such as band-pass filters (BPFs), low-pass filters (LPFs) or other types of filters, to generate RE signals 215 for subsequent transmission (e.g., by one or more of the antennas 101 (FIG. 1)).

In some dual-mode aspects of the present disclosure for Wi-Fi communication, the FEM circuitry 200 may be configured to operate in either the 2.4 GHz frequency spectrum or the 5 GHz frequency spectrum. In these aspects of the present disclosure, the receive signal path of the FEM circuitry 200 may include a receive signal path duplexer 204 to separate the signals from each spectrum as well as provide a separate LNA 206 for each spectrum as shown. In these aspects of the present disclosure, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some aspects of the present disclosure, BT communications may utilize the 2.4 GHZ signal paths and may utilize the same FEM circuitry 200 as the one used for WLAN communications.

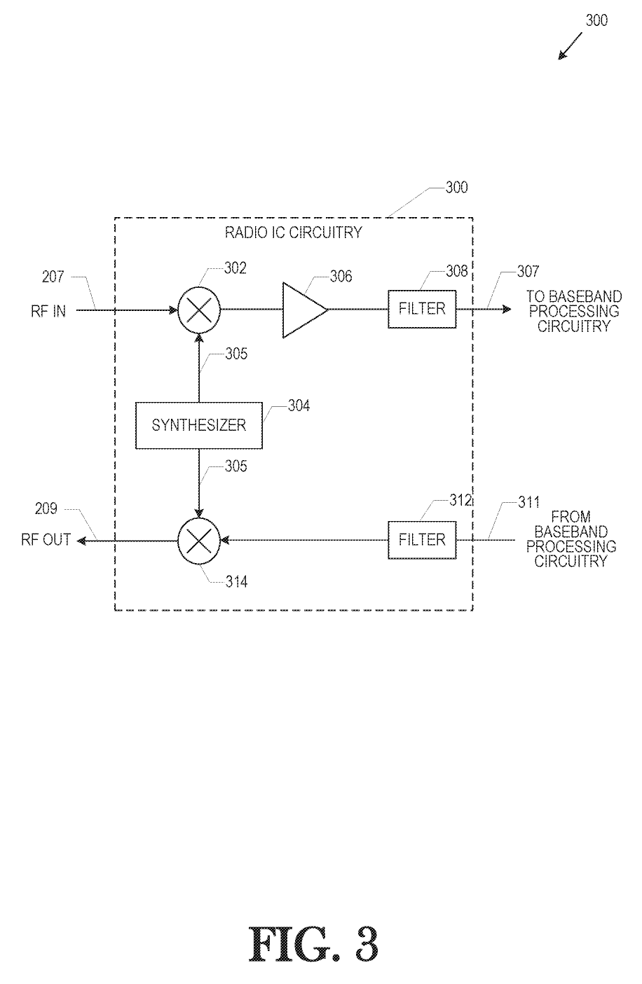

FIG. 3 illustrates radio IC circuitry 300 in accordance with some aspects of the present disclosure. The radio IC circuitry 300 is one example of circuitry that may be suitable for use as the WLAN or BT radio IC circuitry 106A/106B (FIG. 1), although other circuitry configurations may also be suitable.

In some aspects of the present disclosure, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some aspects of the present disclosure, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, aspects of the present disclosure where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

in some aspects of the present disclosure, mixer circuitry 302 may be configured to down-convert RE signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some aspects of the present disclosure, the output baseband signals 307 may be zero-frequency baseband signals, although this is not a requirement. In some aspects of the present disclosure, mixer circuitry 302 may comprise passive mixers, although the scope of the aspects of the present disclosure is not limited in this respect.

In some aspects of the present disclosure, the mixer circuitry 314 may be configured to up-convert input baseband signals 311 based on the synthesized frequency 305 provided by the synthesizer circuitry 304 to generate RE output signals 209 for the FEM circuitry 104. The baseband signals 311 may be provided by the baseband processing circuitry 108 and may be filtered by filter circuitry 312. The filter circuitry 312 may include a LPF or a BPF, although the scope of the aspects of the present disclosure is not limited in this respect.

In some aspects of the present disclosure, the mixer circuitry 302 and the mixer circuitry 314 may each include two or more mixers and may be arranged for quadrature down-conversion and/or up-conversion respectively with the help of synthesizer 304. In some aspects of the present disclosure, the mixer circuitry 302 and the mixer circuitry 314 may each include two or more mixers each configured for image rejection (e.g., Hartley image rejection). In some aspects of the present disclosure, the mixer circuitry 302 and the mixer circuitry 314 may be arranged for direct down-conversion and/or direct up-conversion, respectively. In some aspects of the present disclosure, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 305 of synthesizer 304 (FIG. 3). In some aspects of the present disclosure, the LO frequency may be the carrier frequency, while in other aspects of the present disclosure, the LO frequency may be a fraction of the carrier frequency (e.g., one-half the carrier frequency, one-third the carrier frequency), generated by, e.g., fractional PLL circuitry. In some aspects of the present disclosure, the zero and ninety-degree time-varying switching signals may be generated by the synthesizer, although the scope of the aspects of the present disclosure is not limited in this respect.

In some aspects of the present disclosure, the LO signals may differ in duty cycle (the percentage of one period in which the LO signal is high) and/or offset (the difference between start points of the period). In some aspects of the present disclosure, the LO signals may have a 25% duty cycle and a 50% offset. In some aspects of the present disclosure, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the aspects of the present disclosure is not limited in this respect. The I and Q baseband output signals may be provided to low-nose amplifier, such as amplifier circuitry 306 (FIG. 3) or to filter circuitry 308 (FIG. 3).

In some aspects of the present disclosure, the output baseband signals 307 and the input baseband signals 311 may be analog baseband signals, although the scope of the aspects of the present disclosure is not limited in this respect. In some alternate aspects of the present disclosure, the output baseband signals 307 and the input baseband signals 311 may be digital baseband signals. In these alternate aspects of the present disclosure, the radio IC circuitry may include analog-to-digital converter (ADC) and digital-to-analog converter (DAC) circuitry.

In some dual-mode aspects of the present disclosure, a separate radio IC circuitry may be provided for processing signals for each spectrum, or for other spectrums not mentioned here, although the scope of the aspects of the present disclosure is not limited in this respect.

In some aspects of the present disclosure, the synthesizer circuitry 304 may be a fractional-N synthesizer or a fractional N/N+1 synthesizer, although the scope of the aspects of the present disclosure is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some aspects of the present disclosure, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some aspects of the present disclosure, frequency input into synthesizer circuity 304 may be provided by a voltage controlled oscillator (VCO), although that is not a requirement. A divider control input may further be provided by either the baseband processing circuitry 108 (FIG. 1) or the application processor 110 (FIG. 1) depending on the desired output frequency 305. In some aspects of the present disclosure, a divider control input (e.g., N) may be determined from a look-up table (e.g., within a Wi-Fi card) based on a channel number and a channel center frequency as determined or indicated by the application processor 110.

In some aspects of the present disclosure, synthesizer circuitry 304 may be configured to generate a carrier frequency as the output frequency 305, while in other aspects of the present disclosure, the output frequency 305 may be a fraction of the carrier frequency (e.g., one-half the carrier frequency, one-third the carrier frequency). In some aspects of the present disclosure, the output frequency 305 may be a LO frequency (fLO)

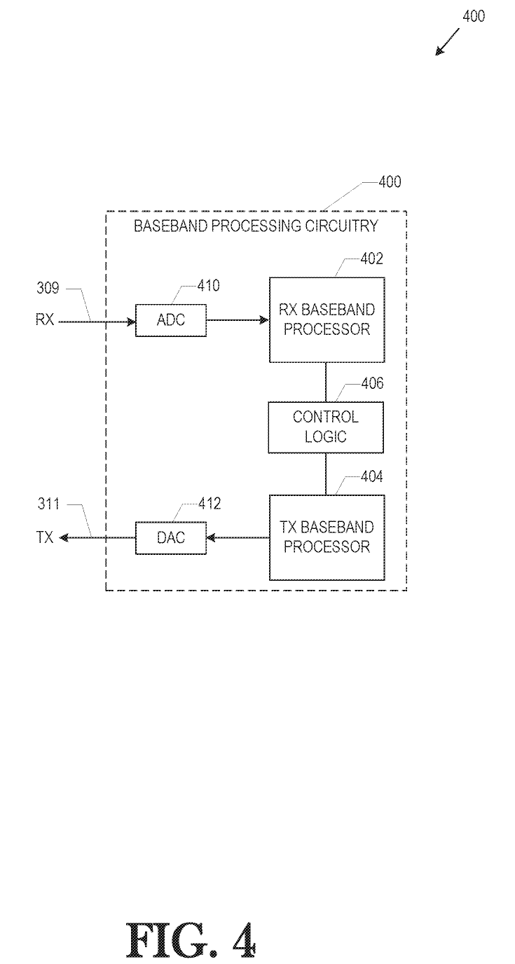

FIG. 4 illustrates a functional block diagram of baseband processing circuitry 400 in accordance with some aspects of the present disclosure. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some aspects of the present disclosure (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these aspects of the present disclosure, the baseband processing circuitry 400 may also include DAC 412 to convert digital baseband signals from the TX BBP 404 to analog baseband signals.

In some aspects of the present disclosure that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some aspects of the present disclosure, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some aspects of the present disclosure, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) aspects of the present disclosure, the antennas may be effectively separated to take advantage of spatial diversity and the different channel characteristics that may result. Antennas 101 may each include a set of phased-array antennas, although aspects of the present disclosure are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some aspects of the present disclosure, the functional elements may refer to one or more processes operating on one or more processing elements.

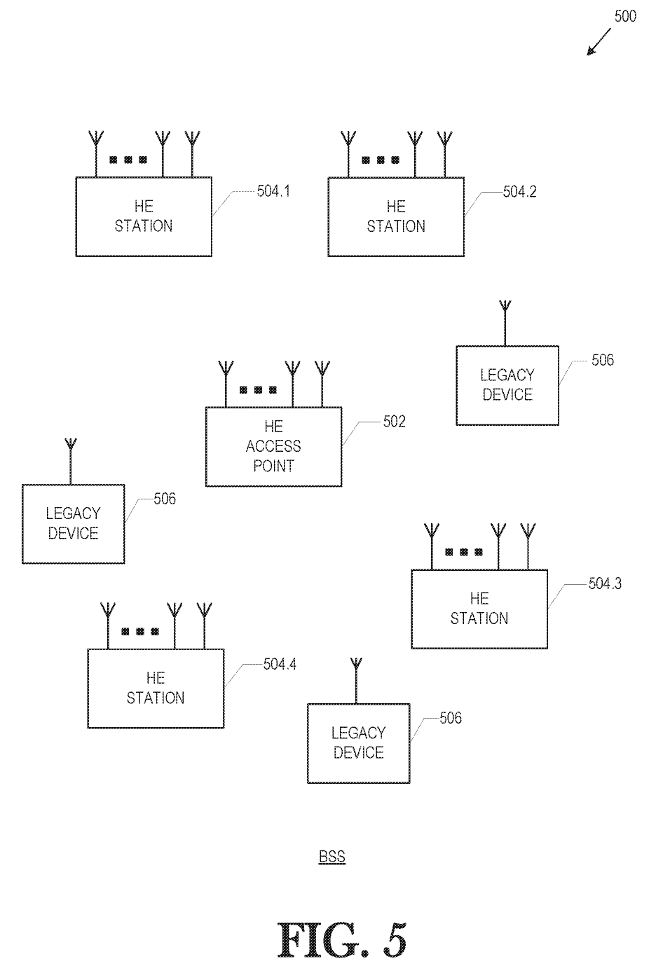

FIG. 5 illustrates a WLAN 500 in accordance with some embodiments. The WLAN 500 may comprise a basic service set (BSS) 500 that may include an HE access point (AP) 502, which may be an AP, a plurality of high-efficiency wireless (e.g., IEEE 802.11ax) (HE) stations 504, and a plurality of legacy (e.g., IEEE 802.11n/ac) devices 506.

The HE access point 502 may be an AP using the IEEE 802.11 protocol to transmit and receive. The HE access point 502 may be a base station. The HE access point 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one HE access point 502 that is part of an extended service set (ESS). A controller (not illustrated) may store information that is common to the more than one HE access points 502.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The HE STAs 504 (e.g., 504.1, 504.2, 504.3, and 504.4) may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 504 may be termed high efficiency (HE) stations.

The HE access point 502 may communicate with legacy devices 506 in accordance with legacy IEEE 802.11 communication techniques. In example embodiments, the HE access point 502 may also be configured to communicate with HE STAs 504 in accordance with legacy IEEE 802.11 communication techniques.

In some embodiments, an HE frame may be configurable to have the same bandwidth as a channel. The HE frame may be a PPDU. In some embodiments, there may be different types of PPDUs that may have different fields and different physical layers and/or different media access control (MAC) layers.

The bandwidth of a channel may be 20 MHz, 40 MHz, 80 MHz, 160 MHz, 320 MHz contiguous bandwidths, or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 506, 242, 484, 996, or 2×996 active data subcarriers or tones that are spaced by 20 MHz, In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHZ, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats, In some embodiments, the 996-subcarrier RU is used in the 160 MHz and 80+80 MHz OFDMA and MU-MIMO HE PPDU formats.

An HE frame may be configured for transmitting a number of spatial streams, which may be in accordance with MU-MIMO and may be in accordance with OFDMA. In other embodiments, the HE access point 502, HE STA 504, and/or legacy device 506 may also implement different technologies such as code division multiple access (CDMA) 2000, CDMA 2000 1X, CDMA 2000 Evolution-Data Optimized (EV-DO), Interim Standard 2000, (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide interoperability for Microwave Access (WiMAX)), BlueTooth®, or other technologies.

Some embodiments relate to HE communications. In accordance with some IEEE 802.11 embodiments, e.g., IEEE 802.11ax embodiments, an HE access point 502 may operate as an HE access point which may be arranged to contend for a wireless medium (e.g., during a contention period) to receive exclusive control of the medium for an HE control period. In some embodiments, the HE control period may be termed a transmission opportunity (TXOP). The HE access point 502 may transmit an HE master-sync transmission, which may be a trigger frame or HE control and schedule transmission, at the beginning of the HE control period. The HE access point 502 may transmit a time duration of the TXOP and sub-channel information. During the HE control period, HE STAs 504 may communicate with the HE access point 502 in accordance with a non-contention based multiple access technique such as OFDMA or MU-MIMO. This is unlike conventional WLAN communications in which devices communicate in accordance with a contention-based communication technique, rather than a multiple access technique. During the HE control period, the HE access point 502 may communicate with HE stations 504 using one or more HE frames. During the HE control period, the HE STAs 504 may operate on a sub-channel smaller than the operating range of the HE access point 502. During the HE control period, legacy stations refrain from communicating. The legacy stations may need to receive the communication from the HE access point 502 to defer from communicating.

In accordance with some embodiments, during the TXOP the HE STAs 504 may contend for the wireless medium with the legacy devices 506 being excluded from contending for the wireless medium during the master-sync transmission. In some embodiments the trigger frame may indicate an UL-MU-MIMO and/or IX OFDMA TXOP. In some embodiments, the trigger frame may include a DL-MU-MIMO and/or DL-OFDMA with a schedule indicated in a preamble portion of trigger frame.

In some embodiments, the multiple-access technique used during the HE TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The HE access point 502 may also communicate with legacy stations 106 and/or HE stations 504 in accordance with legacy IEEE 802.11 communication techniques. In some embodiments, the HE access point 502 may also be configurable to communicate with HE stations 504 outside the HE TXOP in accordance with legacy IEEE 802.11 communication techniques, although this is not a requirement.

In some embodiments the HE station 504 may be a “group owner” (GO) for peer-to-peer modes of operation. A wireless device may be an HE station 504 or an HE access point 502.

In some embodiments, the HE station 504 and/or HE access point 502 may be configured to operate in accordance with IEEE 802.11mc. An HE station 504 and/or HE access point 502 may be termed an HE device (e.g., station or AP), if the FIE device complies with a wireless communication standard IEEE 802.11ax.

In some embodiments, the HE stations 504 may have limited power. In some embodiments, the HE stations 504 may have limited power and may transmit on an RU less than 20 MHz in order to reach the HE access point 502.

In some embodiments associated with IEEE 802.11ax communication systems, a spatial reuse (SR) field may be used in HE PPDUs to enable spatial reuse. There may be four HE PPDU formats: HE single user (SU) PPDU, HE extended range (ER) SU PPDU, HE multi-user (MU) PPDU, and HE trigger-based (TB) PPDU (HE TB PPDU). In some embodiments, 4 bits of spatial reuse field may be allocated for HE SU PPDU, HE ER SU PPDU, and HE MU PPDU. In some embodiments, 16 bits of spatial reuse field are allocated for an HE TB PPDU, where the 16 bits may be divided into 4 separate spatial reuse subfields with 4 bits for each spatial reuse subfield.

In an example embodiment, an AP (e.g., 502) may transmit an uplink (UL) MU Response Scheduling A-control subfield (e.g., using HE MU PPDU) to multiple STAs (e.g., 504) in a BSS and solicit a response PPDU, such as an HE TB PPDU. For the HE TB PPDU solicited by the HE MU PPDU, every solicited STA shall respond with the same HE signal-A (HE-SIG-A) preamble for the HE TB PPDU. PPDU so that neighboring STA can decode the HE-SIG-A of the HE TB PPDU.

In an example embodiment, the HE TB PPDU can be solicited using one of two techniques. The first technique to solicit the HE TB PPDU is through an independent trigger frame (TF). The second technique to solicit the HE TB PPDU is using an UL MU Response Scheduling A-Control subfield in an HE MU PPDU.

In instances when a TF is used to solicit an HE TB PPDU, the TF provides an indication on how the solicited station can set the 16-bit SR field in the HE TB PPDU. However, unlike trigger frames, in instances when UL MU Response Scheduling A-Control subfield in an HE MU PPDU is used to solicit an HE TB PPDU from one or more STAs in a BSS of an access point, there is no indication of how a solicited STA can set the 16-bit spatial reuse field for the solicited HE TB PPDU. In example embodiments, the HE station 504 and/or the HE access point 502 are configured to perform the methods and functions described herein in conjunction with FIGS. 5-13, for setting a spatial reuse field in an HE TB PPDU.

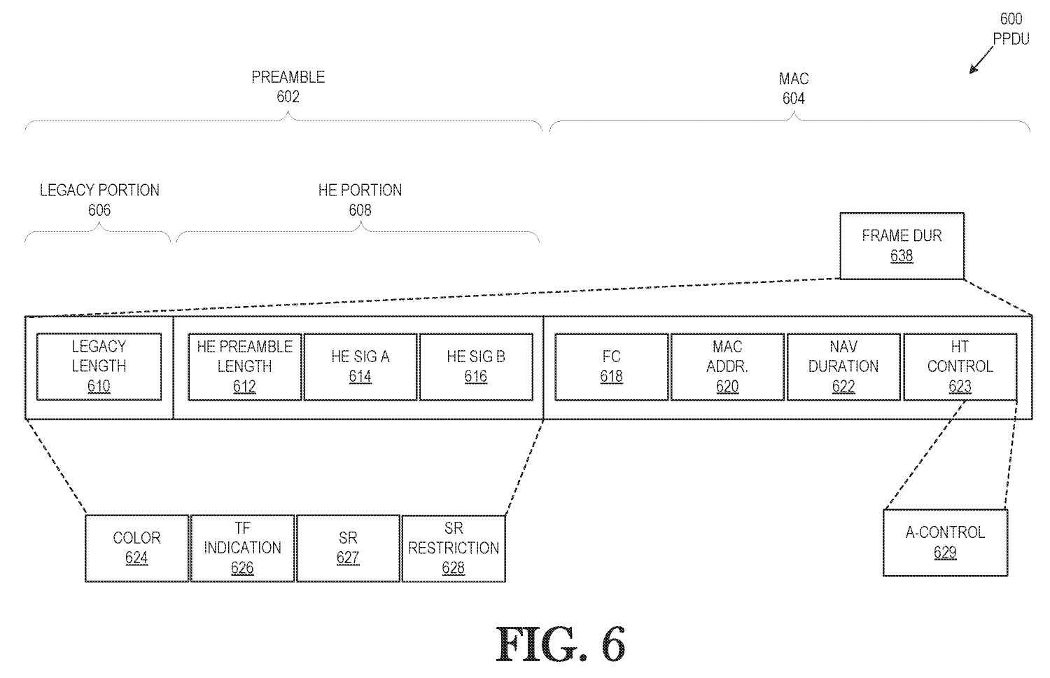

FIG. 6 illustrates a physical layer convergence procedure (PLCP) protocol data unit (PPDU) 600. The PPDU 600 may include a preamble 602 portion and MAC 604 portion. The preamble 602 portion may include a legacy portion 606 and an HE portion 608. The legacy portion 606 may include a legacy length 610 field. A frame (PPDU) duration 638 may be part of the legacy portion 606, HE portion 608, and/or MAC 604 portion. The HE portion 608 may include one or more of an HE preamble length 612 field, HE signal (SIG) A 614 field, and/or HE SIG B 616 field. In some embodiments, the preamble 602 includes one or more of a color 624 field, TF indication 626 field, a spatial reuse (SR) 627 field, and/or SR restriction 628 field.

The preamble 602 portion and MAC 604 portion may be transmitted on different RU or bandwidths, The MAC 604 portion may include one or more of a frame control (FC) 618 field, a MAC address (ADDR) 620 field, a NAV duration 622 field, and/or high throughput (FIT) control 623 field. The PPDU 600 may be an HE extended range (ER) single user (SU) PPDU, HE SU PPDU, HE TB PPDU, or HE MU PPDU. The legacy length 610 field may be an indication of the length of the PPDU 600 in a SIG field of the legacy portion 606, e.g., a number of symbols. The HE preamble length 612 may be an indication of the length of the PPDU 600 in an HE SIG field, e.g., HE SIG A 614 field.

The color 624 field is not included in the PPDU 600 in accordance with some embodiments. The color 624 field may be a field that indicates a color in the HE portion 608. The color 624 field may be received from an external management entity that manages BSS color 624 fields (e.g., an access point). The color 624 field may be negotiated with neighboring BSSs, e.g., using HE access point to HE access point communication or via a common management entity. The color 624 field may be a BSS color 624 field that indicates a color for a BSS, e.g., the HE access point 502 may determine, negotiate, or be assigned a color, and then indicate (to one or more other STAs) the value of the color in the color 624 field. The color 624 field may be a field in the legacy preamble 606 in accordance with some embodiments. In some embodiments, the color 624 field may be in a very-high throughput (VHT) portion of the preamble 602. In some embodiments, the color 624 field may be in an HE portion 608 of an HE SU PPDU (or another type of PPDU).

The TF indication 626 is not included in the PPDU 600 in accordance with some embodiments. The TF indication 626 may be a field that indicates whether a SR restriction is indicated. In some embodiments, the TF indication 626 may indicate whether the frame or PPDU with preamble 602 includes or is a TF. In some embodiments, the TF indication 626 is indicated as one or more values (or one or more bits) of the SR restriction 628 field. In some embodiments, the TF indication 626 may be that an HE station 504 and/or HE access point 502 is configured to determine that a PPDU includes a TF based on a length of the frame, e.g., legacy length 610, HE preamble length 612, and/or a length in the MAC 604 portion.

The SR 627 field can provide information on whether one or more spatial reuse modes are enabled or allowed. SR allows for utilization of medium resources by early identification of signals (e.g., by overlapping basic service sets, or OBSSs). In accordance with an embodiment, SR can be provided under two SR modes. A first SR mode may require configuration parameters from the transmitting station (e.g., transmit power, overlapping power detect level, receive power level, and so forth). A second SR mode may be used for performing SR based on heuristic determination, and without the need for configuration parameters from the transmitting station.

The SR restriction 628 field is not included in the PPDU 600 in accordance with some embodiments. In some embodiments, SR restriction 628 field indicates whether there is a restriction for SR. In some embodiments, SR restriction 628 field is part of the HE portion 608, e.g., HE SIG A 614. In some embodiments, the SR restriction 628 field has a value that indicates a restriction on SR use. In some embodiments, the SR restriction 628 field has a value that indicates an SR delay restriction on SR use. In some embodiments, a value of the SR restriction 628 field indicates a SR delay that indicates that a SR opportunity does not begin until after the current PPDU has finished being transmitted. In some embodiments, an additional time may be added to the PPDU transmission time such as an inter-frame space that is longer than that used for clear channel assessment (CCA). In some embodiments, a value of the SR restriction 628 field indicates a SR restriction that the SR opportunity only last as long as the current PPDU is being transmitted. In some embodiments, a value of the SR restriction 628 field indicates a SR restriction that the SR is not allowed. In some embodiments, a value of the SR restriction 628 field indicates there is no SR restriction for the SR opportunity.

The FC 618 may include information related to the PPDU 600. For example, the FC 618 may include a field that indicates the type of PPDU the PPDU 600 is, e.g., HE MU PPDU TF.

The MAC address 620 field may be a MAC address of a sender of the PPDU 600. The NAV duration 622. field may be an indication of how long a NAV should be set to defer to comply with the transmitter of the PPDU 600, e.g., an HE access point 502 may transmit the PPDU 600 and be a TXOP holder and a receiver may be an HE station 504 that is not addressed in the PPDU 600.

In some embodiments, the HT Control field 623 within the MAC portion 604 of PPDU 600 may include an aggregate control (A-Control) subfield 629. The A-Control subfield 629 can include one or more control subfields with control information. In an example, the A-Control subfield may include UL MU response scheduling information, which may be used (e.g., by the AP 502) to trigger HE TB PPDU from one or more STAs (e.g., 504)

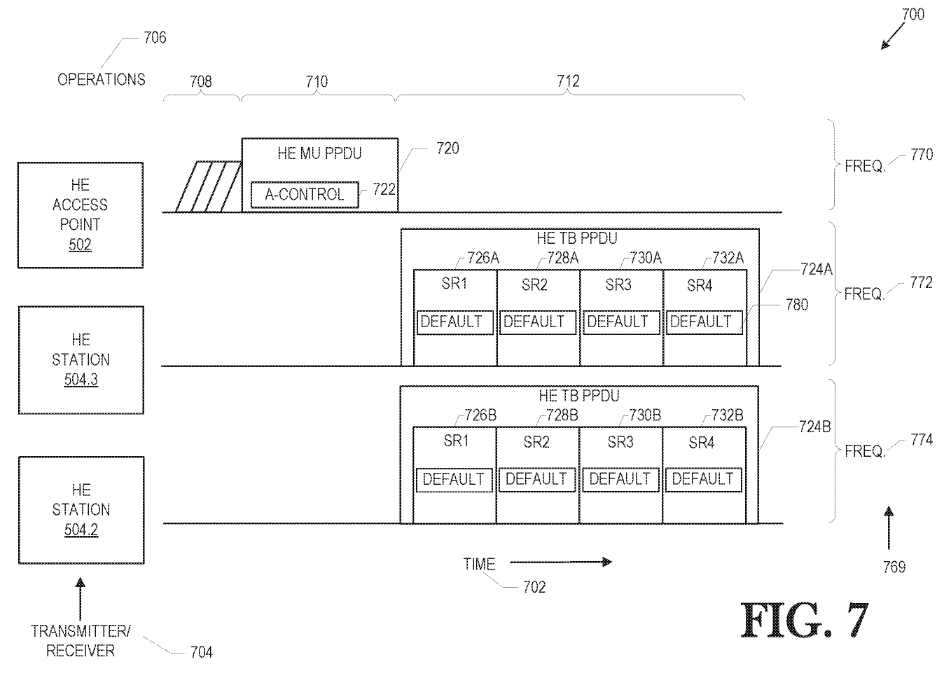

In some embodiments, example SR setting techniques described herein (e.g., in reference to FIGS. 7-13) can be used to ensure multiple STAs solicited by UL MU Response Scheduling A-Control subfield of an HE MU PPDU can set the same value for the spatial reuse field of the HE TB PPDU. Additionally, some SR setting techniques can be used to set the same value for the spatial reuse field of the HE TB PPDUs when trigger frame and UL MU Response Scheduling A-Control subfield are used simultaneously in a DL MU PPDU to solicit the HE TB PPDUs.

FIG. 7 illustrates a timing diagram of a method 700 for setting spatial reuse (SR) field for high efficiency (HE) trigger-based (TB) PPDU in accordance with some embodiments. Illustrated in FIG. 7 is time 702 along a horizontal axis, transmitter/receiver 704 along a vertical axis, frequency 769 along a vertical axis, and operations 706 along the top. HE stations 504.3 and 504.2 are associated with HE access point 502 in BSS 500.

The frequency 769 may be a bandwidth (e.g., an RU). The frequency 769 may overlap. For example, frequency 770 may be the same or overlap with frequencies 772 and/or 774 (e.g., HE MU PPDU 720 may be transmitted on a same RU as UL PPDUs 724A and 724B).

The method 700 begins with operation 708 with HE access point 502 contending for the wireless medium, e.g., performing a clear channel assessment (CCA). The method 700 continues at operation 710 with the HE access point 502 transmitting an HE MU PPDU 720. The HE MU PPDU 720 can include an A-Control field 722, which can be used to solicit HE TB PPDUs from one or more STAs within the BSS associated with the AP 502. For example, the A-Control field can include UL MU Response Scheduling information used for soliciting HE TB PPDUs.

The method 700 continues at operation 712 when the STAs 504.3 and 504.2 receive the HE MU PPDU 720 and send HE TB PPDUs 724A and 724B in response to the HE MU PPDU 720.

In some embodiments, the HE TB PPDUs 724A and 724B each includes a 16-bit SR field (e.g., as part of an HE-SIG-A field in a preamble portion of the PPDU). For example, the HE TB PPDU 724A can include four SR subfields 726A, 728A, 730A, and 732A, which can be 4 bits each. Similarly, the HE TB PPDU 724B can include four SR subfields 726B, 728B, 730B, and 732B, which can also be 4 bits each.

In some embodiments, the 16 bits spatial reuse field (e.g., 726A-732A and 726B 732B) in the HE TB PPDU 724A and 724B solicited by the UL MU Response Scheduling A-Control subfield 722 can be set to a common entry. The common entry may be determined (and communicated) by the STA/AP that solicits the HE TB PPDU. In an example and as illustrated in FIG. 7, the four spatial reuse subfields (e.g., 726A-732A and 726B-732B) in the HE TB PPDU 724A and 724B are all set to a default entry 780. The default entry can include, for example, a SR_Disallowed entry, which disallows the spatial reuse based on the spatial reuse field. For example, SR_Disallowed may be used to disallow use of a first SR mode (e.g., based on the use of transmitter configuration parameters) but allow a second SR mode (e.g., based on a heuristic determination and not depending on the SR field). In an example, the default entry 780 can include a reserved entry for the spatial reuse subfield in the HE TB PPDUs 724A and 724B. The reserved entry may be known by all STAs within the BSS 500 in advance or at the time of association with the AP 502. In an example, the default entry 780 can include a SR_Disable entry, which can be used to disable spatial reuse operation in its entirety (e.g., disable both the first and the second SR modes mentioned above). In an example, the default entry 780 can be indicated by the AP 502 during the association process.

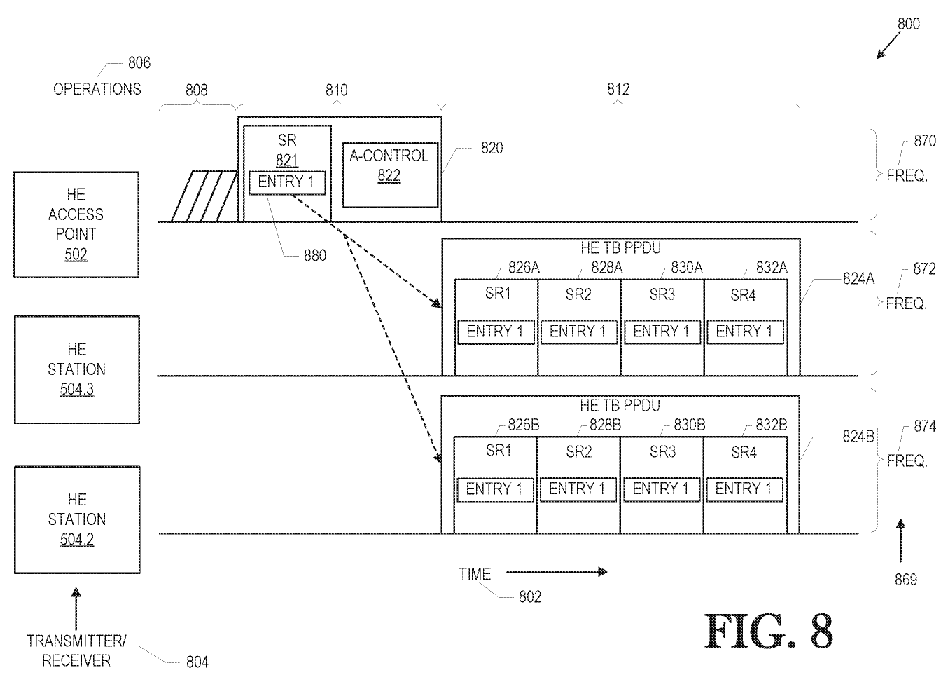

FIG. 8 illustrates another timing diagram of a method for setting SR field for HE TB PPDU in accordance with some embodiments. Illustrated in FIG. 8 is time 802 along a horizontal axis, transmitter/receiver 804 along a vertical axis, frequency 869 along a vertical axis, and operations 806 along the top. HE stations 504.3 and 504.2 are associated with HE access point 502 in BSS 500.

The frequency 869 may be a bandwidth (e.g., an RU). The frequency 869 may overlap. For example, frequency 870 may be the same or overlap with frequencies 872 and/or 874 (e.g., HE MU PPDU 520 may be transmitted on a same RU as UL PPDUs 824A and 824B).

The method 800 begins with operation 808 with HE access point 502 contending for the wireless medium, e.g., performing a clear channel assessment (CCA). The method 800 continues at operation 810 with the HE access point 502 transmitting an HE MU PPDU 820. The HE MU PPDU 820 can include an A-Control field 82 , which can be used to solicit HE TB PPDUs from one or more STAs within the BSS associated with the AP 502. For example, the A-Control field can include UL MU Response Scheduling information used for soliciting HE TB PPDUs. Additionally, the HE MU PPDU 820 can include an SR field 821, which can be part of an HE SIG A field within an FIE preamble portion of the HE MU PPDU 820. The SR field 821 can store an entry 880.

The method 800 continues at operation 812 when the STAs 504.3 and 504.2 receive the HE MU PPDU 820 and send HE TB PPDUs 824A and 824B in response to the HE MU PPDU 820.

In some embodiments, the HE TB PPDUs 824A and 824B each includes a 16-bit SR field (e.g., as part of an FIE-SIG-A field in a preamble portion of the PPDU). For example, the HE TB PPDU 824A can include four SR subfields 826A, 828A, 830A, and 832A, which can be 4 bits each. Similarly, the HE TB PPDU 824B can include four SR subfields 826B, 828B, 830B, and 832B, which can also be 4 bits each.

In some embodiments, if the soliciting frame 820 is an HE MU PPDU and the spatial reuse field (e.g., 821) of the HE MU PPDU is set to a predefined entry (e.g., 880), then the HE TB PPDUs (e.g., 824A and 824B) solicited by the UL MU Response Scheduling A-Control subfield 822 in the HE MU PPDU 820 can include SR subfields (e.g., 826A-832A and 826B 832B) set to the same entry 880 carried in the spatial reuse field 821 of the soliciting HE MU PPDU 820. Otherwise, the four spatial reuse subfields in each of the HE TB PPDUs 824A and 824B can be set to a default entry.

in an example, the predefined entry can be a SR_Disallowed entry, which (as explained above) can be used to disallow the spatial reuse based on the signaling in the spatial reuse field; or SR Disabled entry, which can be used to disable all modes of the spatial reuse operation. In an example, the default entry for each SR subfield can be set as explained in reference to FIG. 7.

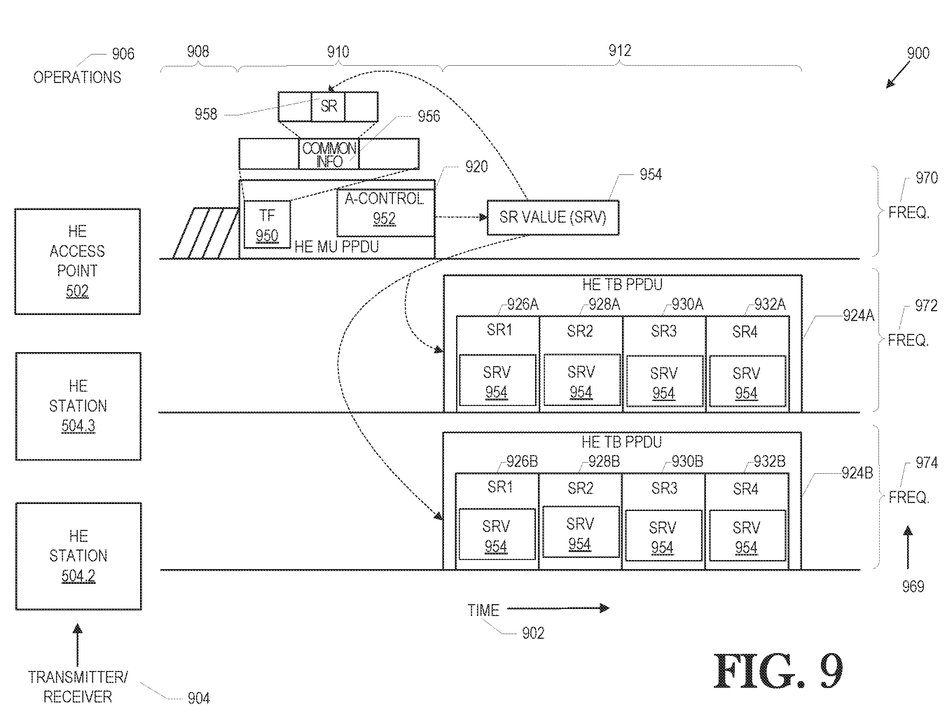

FIG. 9 illustrates yet another timing diagram of a method for setting SR field for HE TB PPDU in accordance with some embodiments. Illustrated in FIG. 9 is time 902 along a horizontal axis, transmitter/receiver 904 along a vertical axis, frequency 969 along a vertical axis, and operations 906 along the top. HE stations 904.3 and 904.2 are associated with HE access point 902 in BSS 900.

The frequency 969 may be a bandwidth (e.g., an RU). The frequency 969 may overlap. For example, frequency 970 may be the same or overlap with frequencies 972 and/or 974 (e.g., HE MU PPDU 920 may be transmitted on a same RU as UL PPDUs 924A and 92413).

The method 900 begins with operation 908 with HE access point 502 contending for the wireless medium, e.g., performing a clear channel assessment (CCA). The method 900 continues at operation 910 with the FIE access point 502 transmitting an HE MU PPDU 920. The HE MU PPDU 920 can include an A-Control field 952, which can be used to solicit HE TB PPDUs from one or more STAs within the BSS associated with the AP 502. For example, the A-Control field 952 can include UL MU Response Scheduling information used for soliciting HE TB PPDUs. Additionally, the HE MU PPDU 920 can include a trigger frame (TF) 950. The TF 950 can be used for soliciting and allocating resources for UL MU transmissions (e.g., soliciting HE TB PPDUs). In an example, the TF 950 can include information required by the responding STA for sending an HE TB PPDU. For example, the TF 950 can include a common info field 956, which can include a SR. field 958. In an example, the SR. field 958 can be 16-bits long and can include the SR information for use by the responding STA for inclusion within the SR subfields of an HE TB PPDU.

As illustrated in FIG. 9, an HE MU PPDU 920 can include a trigger frame 950 carried in a certain RU to solicit an HE TB PPDU, and a UL MU Response Scheduling A-Control subfield 952 carried in another RU to also solicit an HE TB PPDU. To ensure that solicited STA can generate the same value for the spatial reuse in the solicited HE TB PPDU, one or more of the following techniques can be used.

In an example, the soliciting STA (e.g., AP 502) can either use a trigger frame (950) or UL MU Response Scheduling A-Control subfield (952) to solicit HE TB PPDU responses. In this regard, the soliciting STA will not mix the usage of trigger frame and UL MU Response Scheduling A-Control subfield in one HE MU PPDU to solicit HE TB PPDU response.

In an example, a trigger frame (e.g., 950) and UL MU Response Scheduling A-Control subfield (e.g., 952) in one HE MU PPDU are mixed to solicit the HE TB PPDU response (as seen in FIG. 9). In this case, the 16 bits spatial reuse field (958) in the common info field (956) of the trigger frame (950) may be set to the same value (e.g., SRV 954) as the spatial reuse field (e.g., 926A-932A and 926B-932B) in the HE TB PPDUs (924A and 924B) solicited by the UL MU Response Scheduling A-Control subfield (952) in the HE MU PPDU (920).

Put another way, the SR value (SRV) 954 can be determined based on the techniques described in connection with FIG. 7 or FIG. 8 (i.e., based on setting the SR subfields in an HE TB PPDUs solicited by A-Control subfield in an HE MU PPDU. Once the SRV 954 is determined, the same value can be stored in the SR field 958 of the TF 950. In this way, an HE TB PPDU solicited by a TF or by A-Control subfield 952 can result in an HE TB PPDU with the same information in the 16-bit SR field, regardless of whether the HE TB PPDU is triggered by a TF or by a A-Control subfield.

In some embodiments, the HE TB PPDUs 924A and 924B each includes a 16-bit SR field (e.g., as part of an HE-SIG-A field in a preamble portion of the PPDU). For example, the HE TB PPDU 924A can include four SR subfields 926A, 928A, 930A, and 932A, which can be 4 bits each. Similarly, the HE TB PPDU 924B can include four SR subfields 926B, 928B, 930B, and 932B, which can also be 4 bits each.

The method 900 continues at operation 912 when the STAs 504.3 and 504.2 receive the HE MU PPDU 920 and send HE TB PPDUs 924A and 924B in response to the HE MU PPDU 920, More specifically, the SRV 954 can be determined (e.g., based on techniques described in connection with FIG. 7 or FIG. 8), and the same SRV 954 can be stored in the SR subfields 926A-932A and 926B-932B in HE TB PPDUs 924A and 924B, respectively.

In an example, if UL MU Response Scheduling A-Control subfield is used in an HE MU PPDU to solicit HE TB PPDU, then the spatial reuse field of the HE MU PPDU can be set to the SR Disallowed entry, a reserved entry, or a SR_Disable (as explained herein above in reference to FIG. 8).

In an example, a BSS color of 0, or a specific BSS color, can be used by the soliciting HE MU PPDU to disable spatial reuse completely (e.g., using the color field 624 illustrated in FIG. 6). For example, if BSS color 0, or a specific BSS color, is used in the HE MU PPDU carrying the UL MU Response Scheduling A-Control subfield to solicit the HE TB PPDU, then the BSS color field in the solicited HE TB PPDU may be set to BSS color 0, or the specific BSS color.

In an example, if BSS color 0, or a specific BSS color, is used in the HE MU PPDU carrying the UL MU Response Scheduling A-Control subfield to solicit the HE TB PPM, then the four spatial reuse subfields in the HE TB PPDU may be set to a common value, which can be: (a) copied from the spatial reuse field of the soliciting HE MU PPDU; or (b) a default entry, such as the SR Disallowed entry, a reserved entry, or an entry indicated by the AP during the association process.

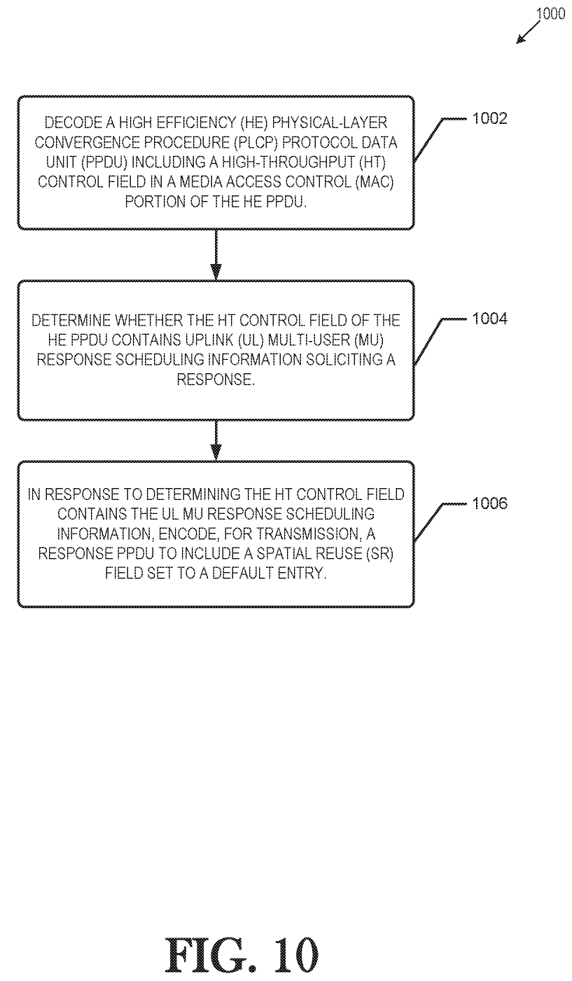

FIG. 10 illustrates a method for setting SR. field for HE TB PPDU in accordance with some embodiments. Referring to FIG. 10, the example method 1000 may start at 1002, when a high efficiency (HE) physical-layer convergence procedure (PLCP) protocol data unit (PPDU) can be decoded. For example and in reference to FIGS. 7-8, the HE STA 504.3 can decode the HE MU PPDU 720 received from the HE AP 502. The HE MU PPDU may include a high-throughput (HT) control field (e.g., 623) in a media access control (MAC) portion of the HE PPDU, At 1004, the HE STA 504.3 may determine whether the HT control field of the HE PPDU contains uplink (UL) multi-user (MU) response scheduling information soliciting a response. For example, the HE STA 504.3 may determine that the HE MU PPDU 720 includes UL MU response scheduling information in an A-Control subfield 722, soliciting a response HE TB PPDU. At 1006, in response to determining the HT control field contains the UL MU response scheduling information, a response PPDU can be encoded, for transmission, to include a spatial reuse (SR) field set to a default entry. For example, the HE STA 504.3 can encode a response HE TB PPDU 724A to include the default entry 780 in all 4 SR subfields 726A-732A.

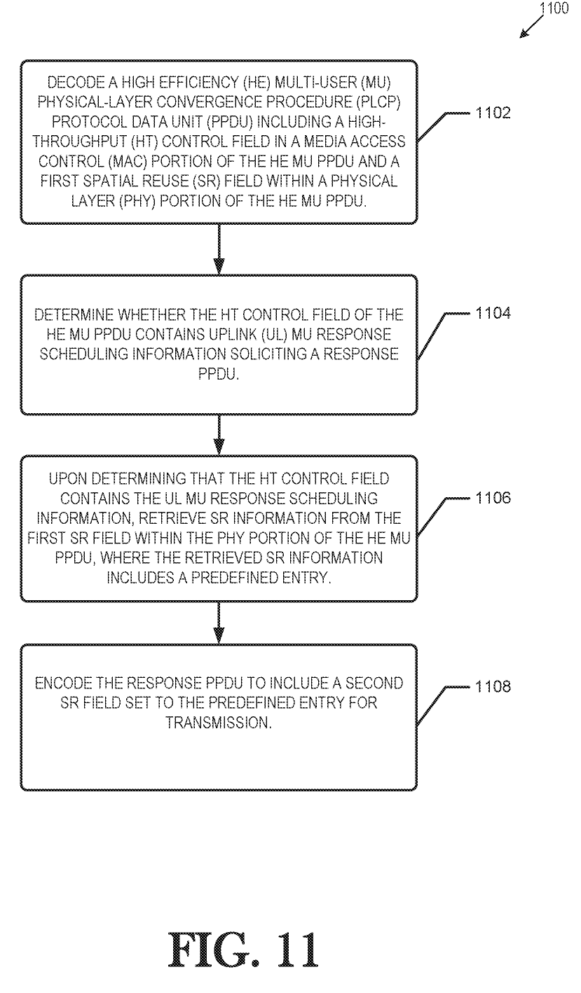

FIG. 11 illustrates a method for setting SR field for HE TB PPDU in accordance with some embodiments. Referring to FIG. 11 and FIG. 8, the example method 1100 may start at 1102, when a high efficiency (FIE) multi-user (MU) physical-layer convergence procedure (PLCP) protocol data unit (PPDU) can be decoded. For example, the HE STA 504.3 can decode the HE MU PPDU 820 received from the HE AP 502. The HE MU PPDU may include a high-throughput (HT) control field (e.g., 623) in a media access control (MAC) portion of the HE PPDU and a spatial reuse (SR) field (e.g., 821) within a physical layer (PHY) portion of the HE MU PPDU 820, At 1104, the HE STA 504.3 can determine whether the HT control field of the HE MU PPDU contains uplink (UL) MU response scheduling information soliciting a response PPDU. For example, the HE STA 504.3 may determine that the HE MU PPDU 820 includes UL MU response scheduling information in an A-Control subfield 822, soliciting a response HE TB PPDU, At 1106, upon determining that the HT control field contains the UL MU response scheduling information, the HE STA 504.3 can retrieve SR information (e.g., 880) from the SR field (e.g., 821) within the preamble portion of the HE MU PPDU. In an example, the retrieved SR information includes a predefined entry. At 1108, the response PPDU can be encoded to include a SR field set to the predefined entry for transmission. For example and as seen in FIG. 8, the HE TB PPDU 824A can be encoded for transmission so that the SR subfields 826A-832A include the predefined entry 880 from the SR field 821 within the soliciting HE MU PPDU 820.

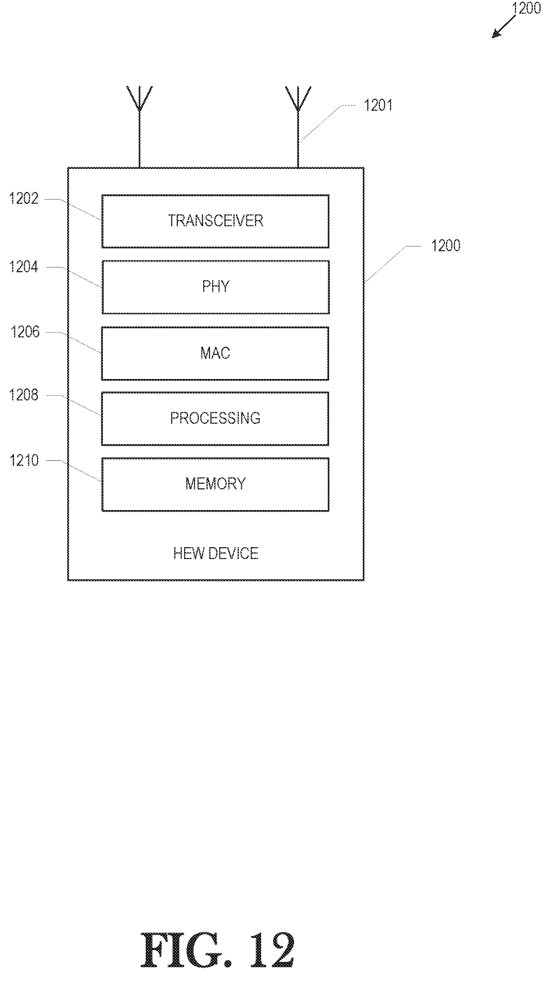

FIG. 12 illustrates an HE station in accordance with some embodiments. HEW device 1200 may be an HEW compliant device that may be arranged to communicate with one or more other HEW devices, such as HEW devices 504 or access point 502 (FIG. 5) as well as communicate with legacy devices 506 (NG. 5). HEW devices 504 and legacy devices 506 may also be referred to as HEW stations (STAs) and legacy STAs, respectively. HEW device 1200 may be suitable for operating as access point 502 (FIG. 5) or an HEW device 504 (FIG. 5).

In accordance with embodiments, HEW device 1200 may include, among other things, a transmit/receive element 1201 (for example, an antenna), a transceiver 1202, PHY circuitry 1204, and MAC 1206. PHY 1204 and MAC 1206 may be HEW compliant layers and may also be compliant with one or more legacy IEEE 802.11 standards. MAC 1206 may be arranged to configure PPDUs and arranged to transmit and receive PPDUs, among other things. HEW device 1200 may also include other processing hardware circuitry 1208 and memory 1210 both of which may be configured to perform the various operations described herein. The hardware circuitry 1208 may be coupled to the transceiver 1202, which may be coupled to the transmit/receive element 1201. While FIG. 12 depicts the hardware circuitry 1208 and the transceiver 1202 as separate components, the hardware circuitry 1208 and the transceiver 1202 may be integrated together in an electronic package or chip. For example, the hardware circuitry and the transceiver 1202 can be part of a wireless circuit card, such as 102 in FIGS. 1-4.

In example embodiments, the HEW device 1200 is configured to perform one or more of the functions and/or methods described herein in conjunction with FIGS. 6-13 such as setting of a spatial reuse field for HE TB PPDU.

The PHY 1204 may be arranged to transmit the HE PPDU using the transceiver 1202. The PHY 1204 may include circuitry for modulation/demodulation, upconversion/downconversion, filtering, amplification, and so forth. For example, the PHY 1204 can include radio IC circuitry (e.g., 106A, 106B) and baseband processing circuitry (e.g., 108A, 108B), The transceiver 1202 can include front-end module circuitry((e.g., 104A, 104B in FIGS. 1-4).

In some embodiments, the hardware circuitry 1208 may include one or more processors. The hardware circuitry 1208 may be configured to perform functions based on instructions being stored in a random access memory (RAM) or read-only memory (ROM), or based on special purpose circuitry. In some embodiments, the hardware circuitry 1208 may be configured to perform one or more of the functions and/or methods described herein in conjunction with FIGS. 6-13 such as setting of a spatial reuse field for HE TB PPDU.

In some embodiments, two or more antennas may be coupled to the PHY 1204 and arranged for sending and receiving signals including transmission of the HEW packets. The HEW device 1200 may include a transceiver 1202 to transmit and receive data such as HEW PPDU and packets that include an indication that the HEW device 1200 should adapt the channel contention settings according to settings included in the packet. The memory 1210 may store information for configuring the other circuitry to perform operations for one or more of the functions and/or methods described herein for methods of transmitting pilot carriers, interpreting received pilot carriers, and generating and interpreting indications of which methods of transmitting pilot carriers to use.

In some embodiments, the HEW device 1200 may be configured to communicate using OFDM and/or OFDMA communication signals over a multicarrier communication channel. In some embodiments, HEW device 1200 may be configured to communicate in accordance with one or more specific communication standards, such as the IEEE standards including IEEE 802.11-2012, 802.11n-2009, 802.11ac-2013, 802.11ax, standards and/or proposed specifications for WLANs, although the scope of the example embodiments is not limited in this respect as they may also be suitable to transmit and/or receive communications in accordance with other techniques and standards. In some embodiments, the HEW device 1200 may use 4× symbol duration of 802.11n or 802.11ac.

In some embodiments, an HEW device 1200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be a liquid crystal display (LCD) screen including a touch screen.

The transmit/receive element 1201 may comprise one or more directional or omnidirectional antennas, including, for example, dipole antennas, phased antenna arrays, monopole antennas, patch antennas, loop antennas, microstrip antennas or other types of antennas suitable for transmission of radio frequency (RF) signals. In some MIMO embodiments, the antennas may be effectively separated to take advantage of spatial diversity and the different channel characteristics that may result.

Although the device 1200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

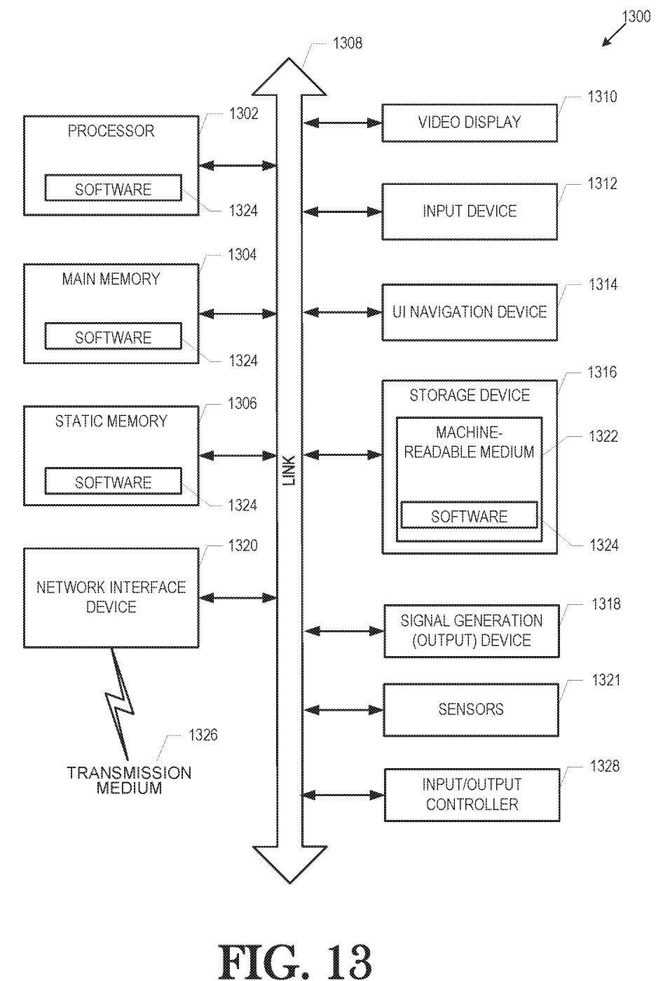

FIG. 13 illustrates a block diagram of an example machine upon which any one or more of the techniques (e.g., methodologies) discussed herein may perform. In alternative embodiments, the communication device 1300 may operate as a standalone device or may be connected (e.g., networked) to other communication devices. In a networked deployment, the communication device 1300 may operate in the capacity of a server communication device, a client communication device, or both in server-client network environments. In an example, the communication device 1300 may act as a peer communication device in peer-to-peer (P2P) (or other distributed) network environment. The communication device 1300 may be a personal computer (PC), a tablet PC, a set top box (STB), a personal digital assistant (PDA), a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device 1300 may include a hardware processor 1302. (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The communication device 1300 may further include a display unit 1310, an input device 1312 (e.g., a keyboard), and a user interface (UI) navigation device 1314 (e.g., a mouse). In an example, the display unit 1310, input device 1312, and UI. navigation device 1314 may be a touch screen display. In an example, the input device 1312 may include a touchscreen, a microphone, a camera (e.g., a panoramic or high-resolution camera), physical keyboard, trackball, or other input devices.

The communication device 1300 may additionally include a storage device (e.g., drive unit) 1316, a signal generation device 1318 (e.g., a speaker, a projection device, or any other type of information output device), a network interface device 1320, and one or more sensors 1321, such as a global positioning system (GPS) sensor, compass, accelerometer, motion detector, or other sensor. The communication device 1300 may include an input/output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.) via one or more input/output ports.

The storage device 1316 may include a communication device machine) readable medium 1322, on which is stored one or more sets of data structures or instructions 1324 (e.g., software) embodying or utilized by any one or more of the techniques or functions described herein. In an example, at least a portion of the software may include an operating system and/or one or more applications (or apps) implementing one or more of the functionalities described herein. The instructions 1324 may also reside, completely or at least partially, within the main memory 1304, within the static memory 1306, and/or within the hardware processor 1302 during execution thereof by the communication device 1300. In an example, one or any combination of the hardware processor 1302, the main memory 1304, the static memory 1306, or the storage device 1316 may constitute communication device (or machine) readable media.

While the communication device readable medium 1322 is illustrated as a single medium the term “communication device readable medium” or “machine-readable medium” may include a single medium or multiple media (e.g., a centralized or distributed database, and/or associated caches and servers) configured to store the one or more instructions 1324.

The term “communication device readable medium” or “machine-readable medium” may include any medium that is capable of storing, encoding, or carrying instructions for execution by the communication device 1300 and that cause the communication device 1300 to perform any one or more of the techniques of the present disclosure, or that is capable of storing, encoding or carrying data structures used by or associated with such instructions. Non-limiting communication device readable medium examples may include solid-state memories, and optical and magnetic media. Specific examples of communication device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device readable media may include non-transitory communication device readable media. In some examples, communication device readable media may include communication device readable media that is not a transitory propagating signal. The term “communication device readable medium” or “machine-readable medium” do not include signals or carrier waves.

The instructions 1324 may further be transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.9 family of standards known as Wi-Fi®, IEEE 802.16 family of standards known as WiMax®), IEEE 802.15.4 family of standards, a Long Term Evolution (LTE) family of standards, a Universal Mobile Telecommunications System (UNITS) family of standards, peer-to-peer (P2P) networks, among others.

In an example, the network interface device 1320 may include one or more physical jacks (e.g., Ethernet, coaxial, or phone jacks) or one or more antennas to connect to the communications network 1326. In an example, the network interface device 1320 may include one or more wireless modems, such as a Bluetooth modem, a Wi-fi modem or one or more modems or transceivers operating under any of the communication standards mentioned herein. In an example, the network interface device 1320 may include a plurality of antennas to wirelessly communicate using at least one of single-input multiple-output (SIMO), MIMO, or multiple-input single-output (MISO) techniques. In some examples, the network interface device 1320 may wirelessly communicate using Multiple User MIMO techniques. The term “transmission medium” shall be taken to include any intangible medium that is capable of storing, encoding or carrying instructions for execution by the communication device 1300, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured. or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a. tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments:

Example 1 is an apparatus of a wireless device comprising: memory; and processing circuitry coupled to the memory, the processing circuitry configured to: decode a high efficiency (HE) physical-layer convergence procedure (PLCP) protocol data unit (PPDU) comprising a high-throughput (HT) control field in a media access control (MAC) portion of the HE PPDU; determine whether the HT control field of the FIE PPDU contains uplink (UL) multi-user (MU) response scheduling information soliciting a response; and in response to determining the HT control field contains the UL MU response scheduling information, encode, for transmission, a response PPDU to include a spatial reuse (SR) field set to a default entry.

In Example 2, the subject matter of Example 1 optionally includes wherein the wireless device is within a basic service set (BSS) associated with an access point (AP), and wherein the HE PPDU is an HE multi-user (MU) PPDU received from the AP and soliciting a response from the wireless device and at least another wireless device within the BSS.

in Example 3, the subject matter of Example 2 optionally includes wherein the default entry is received from the AP during an association process between the AP and the wireless device.

In Example 4, the subject matter of any one or more of Examples 1-3 optionally include wherein the processing circuitry is configured to: decode an aggregate control (A-Control) subfield of the HT control field to obtain the UL MU response scheduling information.

In Example 5, the subject matter of any one or more of Examples 1-4 optionally include wherein the UL MU response scheduling information comprises: information indicating length of the response PPDU; information indicating resource units (RUs) assigned for transmitting the response PPDU; and information indicating UL modulation coding scheme (MCS) for use during the transmitting of the response PPDU.

In Example 6, the subject matter of any one or more of Examples 1-5 optionally include wherein the processing circuitry is configured to: retrieve the default entry from the memory.

in Example 7, the subject matter of any one or more of Examples 1-6 optionally include wherein the default entry is a spatial reuse disallowed (SR_Disallowed) entry, configured to cause the processing circuitry to disallow a first spatial reuse operation mode based on transmitter spatial reuse parameters.

In Example 8, the subject matter of Example 7 optionally includes wherein the SR_Disallowed entry is configured to cause the processing circuitry allow a second spatial reuse operation mode based on a heuristic determination and without using the transmitter spatial reuse parameters.

in Example 9, the subject matter of Example 8 optionally includes wherein the default entry is a spatial reuse disabled (SR_Disabled) entry, disabling the first spatial reuse operation mode and the second spatial reuse operation mode.

in Example 10, the subject matter of any one or more of Examples 1-9 optionally include wherein the processing circuitry is configured to: decode a configuration information message with the default entry from a second wireless device, wherein the HE PPDU is received from the second wireless device.

In Example 11, the subject matter of any one or more of Examples 1-10 optionally include wherein the SR field is a subfield within an HE signal A (HE-SIG-A) field of the response PPDU.

In Example 12, the subject matter of any one or more of Examples 1-11 optionally include wherein the response PPDU is an HE trigger-based (TB) PPDU.

In Example 13, the subject matter of Example 12 optionally includes wherein the SR field comprises four SR subfields within an HE signal A (HE-SIG-A) field of the HE TB PPDU, and wherein the processing circuitry is configured to: set each of the four SR subfields to the default entry, wherein each of the SR subfields is at least four bits.

In Example 14, the subject matter of any one or more of Examples 1-13 optionally include transceiver circuitry coupled to the memory; and one or more antennas coupled to the transceiver circuitry.

Example 15 is an apparatus of a wireless device comprising: memory; and processing circuitry coupled to the memory, the processing circuitry configured to: decode a high efficiency (HE) multi-user (MU) physical-layer convergence procedure (PLCP) protocol data unit (PPDU) comprising a high-throughput (HT) control field in a media access control (MAC) portion of the HE MU PPDU and a first spatial reuse (SR) field within a physical layer (PHY) portion of the HE MU PPDU; determine whether the HT control field of the HE MU PPDU contains uplink (UL) MU response scheduling information soliciting a response PPDU; upon a determination that the HT control field contains the UL MU response scheduling information, retrieve SR information from the first SR field within the PHY portion of the HE MU PPDU, wherein the retrieved SR information comprises a predefined entry; and encode the response PPDU to include a second SR field set to the predefined entry for transmission.

In Example 16, the subject matter of Example 15 optionally includes bits and the second SR field includes multiple copies of the first SR field.

In Example 17, the subject matter of any one or more of Examples 15-16 optionally include wherein the processing circuitry configured to: decode a second PPDU comprising a second HT control field in a MAC portion of the PPDU, the second HT control field including UL MU resource scheduling information soliciting a second response PPDU; and determine whether a PHY portion of the second PPDU includes an SR field.

In Example 18, the subject matter of Example 17 optionally includes wherein the processing circuitry configured to: in response to determining the PHY portion of the second PPDU does not includes an SR field, encode the second response PPDU to include a third SR field set to a default entry for transmission.

In Example 19, the subject matter of any one or more of Examples 15-18 optionally include wherein the default entry is a spatial reuse disallowed (SR_Disallowed) entry, disallowing a first spatial reuse operation mode based on transmitter spatial reuse parameters.

In Example 20, the subject matter of Example 19 optionally includes wherein the SR_Disallowed entry allows a second spatial reuse operation mode based on a heuristic determination and without using the transmitter spatial reuse parameters.

In Example 21, the subject matter of Example 20 optionally includes wherein the default entry is a spatial reuse disabled (SR_Disabled) entry, disabling the first spatial reuse operation mode and the second spatial reuse operation mode.

Example 22 is an apparatus of an access point (AP) comprising: memory; and processing circuitry coupled to the memory, the processing circuitry configured to: encode a high efficiency (HE) multi-user (MU) physical-layer convergence procedure (PLOP) protocol data unit (PPDU) comprising a high-throughput (HT) control field in a media access control (MAC) portion of the HE MU PPDU; encode the HE MU PPDU to include a spatial reuse (SR) field within a physical layer (PHY) portion of the HE MU PPDU and uplink (UL) MU response scheduling information within the HT control field; and configure the AP to transmit the HE MU PPDU to solicit a response PPDU from each of a plurality of wireless devices within a basic service set (BSS) of the AP.

In Example 23, the subject matter of Example 22 optionally includes wherein the processing circuitry is configured to: encode the HE MU PPDU with the UL MU response scheduling information within the HT control field, without including trigger frame (TF) information within the HE MU PPDU.

In Example 24, the subject matter of any one or more of Examples 22-23 optionally include wherein the processing circuitry is configured to: encode the SR field within the PHY portion to include a default entry.

In Example 25, the subject matter of Example 24 optionally includes wherein the default entry is a spatial reuse disallowed (SR_Disallowed) entry, disallowing a first spatial reuse operation mode based on transmitter spatial reuse parameters.

In Example 26, the subject matter of Example 25 optionally includes wherein the SR_Disallowed entry allows a second spatial reuse operation mode based on a heuristic determination and without using the transmitter spatial reuse parameters.

In Example 27, the subject matter of Example 26 optionally includes wherein the default entry is a spatial reuse disabled (SR_Disabled) entry, disabling the first spatial reuse operation mode and the second spatial reuse operation mode.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

The above description is intended to be illustrative, and not restrictive. For example, the above-described examples (or one or more aspects thereof) may be used in combination with others. Other embodiments may be used, such as by one of ordinary skill in the art upon reviewing the above description.

The Abstract is provided to comply with 37 C.F.R. Section 1.72(b) requiring an abstract that will allow the reader to ascertain the nature and gist of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled,

What is claimed is:

1. An apparatus of a wireless device comprising: memory; and processing circuitry coupled to the memory, the processing circuitry configured to:
decode a high efficiency (HE) physical-layer convergence procedure (PLCP) protocol data unit (PPDU) comprising a high-throughput (HT) control field in a media access control (MAC) portion of the HE PPDU;
determine whether the HT control field of the HE PPDU contains uplink (UL) multi-user (MU) response scheduling information soliciting a response; and
in response to determining the HT control field contains the UL MU response scheduling information, encode, for transmission, a response PPDU to include a spatial reuse (SR) field set to a default entry.

2. The apparatus of claim 1, wherein the wireless device is within a basic service set (BSS) associated with an access point (AP), and wherein the HE PPDU is an HE multi-user (MU) PPDU received from the AP and soliciting a response from the wireless device and at least another wireless device within the BSS.

3. The apparatus of claim 2, wherein the default entry is received from the AP during an association process between the AP and the wireless device.

4. The apparatus of claim 1, wherein the processing circuitry is configured to:
decode an aggregate control (A-Control) subfield of the IT control field to obtain the UL MU response scheduling information.

5. The apparatus of claim 1, wherein the UL MU response scheduling information comprises:
information indicating length of the response PPDU;
information indicating resource units (RUs) assigned for transmitting the response PPDU; and
information indicating UL modulation coding scheme: (MCS) for use during the transmitting of the response PPDU.

6. The apparatus of claim 1, wherein the processing circuitry is configured to:
retrieve the default entry from the memory.

7. The apparatus of claim 1, wherein the default entry is a spatial reuse disallowed (SR_Disallowed) entry, configured to cause the processing circuitry to disallow a first spatial reuse operation mode based on transmitter spatial reuse parameters.

8. The apparatus of claim 7, wherein the SR_Disallowed entry is configured to cause the processing circuitry to allow a second spatial reuse operation mode based on a heuristic determination and without using the transmitter spatial reuse parameters.

9. The apparatus of claim 8, wherein the default entry is a spatial reuse disabled (SR_Disabled) entry, disabling the first spatial reuse operation mode and the second spatial reuse operation mode.

10. The apparatus of claim 1, wherein the processing circuitry is configured to:
decode a configuration information message with the default entry from a second wireless device, wherein the HE PPDU is received from the second wireless device.

11. The apparatus of claim 1, wherein the SR field is a subfield within an HE signal A (HE-SIG-A) field of the response PPDU.

12. The apparatus of claim 1, wherein the response PPDU is an HE trigger-based (TB) PPDU.

13. The apparatus of claim 12, wherein the SR field comprises four SR subfields within an HE signal A (HE-SIG-A) field of the HE TB PPDU, and wherein the processing circuitry is configured to:
set each of the four SR subfields to the default entry, wherein each of the SR subfields is at least four bits.

14. The apparatus of claim 1, further comprising:
transceiver circuitry coupled to the memory; and
one or more antennas coupled to the transceiver circuitry.

15. An apparatus of a wireless device comprising: memory; and processing circuitry coupled to the memory, the processing circuitry configured to:
decode a high efficiency (HE) multi-user (MU) physical-layer convergence procedure (PLCP) protocol data unit (PPDU) comprising a high-throughput (HT) control field in a media access control (MAC) portion of the HE MU PPDU and a first spatial reuse (SR) field within a physical layer (PHY) portion of the HE MU PPDU;
determine whether the HT control field of the HE MU PPDU contains uplink (UL) MU response scheduling information soliciting a response PPDU;
upon a determination that the HT control field contains the UL MU response scheduling information, retrieve SR information from the first SR field within the PHY portion of the HE MU PPDU, wherein the retrieved SR information comprises a predefined entry, and
encode the response PPDU to include a second SR field set to the predefined entry for transmission.

16. The apparatus of claim 15, wherein the first SR field is 4 bits and the second SR field includes multiple copies of the first SR field.

17. The apparatus of claim 15, wherein the processing circuitry configured to:
decode a second. PPDU comprising a second HT control field in a MAC portion of the PPDU, the second FIT control field including UL MU resource scheduling information soliciting a second response PPDU; and
determine whether a PRY portion of the second PPDU includes an SR field.

18. The apparatus of claim 17, wherein the processing circuitry configured to:
in response to determining the PHY portion of the second PPDU does not includes an SR field, encode the second response PPDU to include a third SR field set to a default entry for transmission.

19. The apparatus of claim 15, wherein the default entry is a spatial reuse disallowed (SR_Disallowed) entry, disallowing a first spatial reuse operation mode based on transmitter spatial reuse parameters.

20. The apparatus of claim 19, wherein the SR_Disallowed entry allows a second spatial reuse operation mode based on a heuristic determination and without using the transmitter spatial reuse parameters.

21. The apparatus of claim 20, wherein the default entry is a spatial reuse disabled (SR_Disabled) entry, disabling the first spatial reuse operation mode and the second spatial reuse operation mode.

22. An apparatus of an access point (AP) comprising: memory; and processing circuitry coupled to the memory, the processing circuitry configured to:
encode a high efficiency (HE) multi-user (MU) physical-layer convergence procedure (PLCP) protocol data unit (PPDU) comprising a high-throughput (HT) control field in a media access control (MAC) portion of the HE MU PPDU, encode the HE MU PPDU to include a spatial reuse (SR) field within a physical layer (PHY) portion of the HE MU PPDU and uplink (UL) MU response scheduling information within the HT control field; and
configure the AP to transmit the HE MU PPDU to solicit a response PPDU from each of a plurality of wireless devices within a basic service set (BSS) of the AP.

23. The apparatus of claim 22, wherein the processing circuitry is configured to:
encode the HE MU PPDU with the UL MU response scheduling information within the HT control field, without including trigger frame (TF) information within the HE MU PPDU.

24. The apparatus of claim 22, wherein the processing circuitry is configured to:
encode the SR field within the PHY portion to include a default entry.

25. The apparatus of claim 24, wherein the default entry is a spatial reuse disallowed (SR_Disallowed) entry, disallowing a first spatial reuse operation mode based on transmitter spatial reuse parameters.

26. The apparatus of claim 25, wherein the SR_Disallowed entry allows a second spatial reuse operation mode based on a heuristic determination and without using the transmitter spatial reuse parameters.

27. The apparatus of claim 26, wherein the default entry is a spatial reuse disabled (SR_Disabled) entry, disabling the first spatial reuse operation mode and the second spatial reuse operation mode.
